(19) United States
(12) Patent Application Publication
(10) Pub. No.: US 2011/0197743 A1
(43) Pub. Date: Aug. 18, 2011

(54) STRINGED MUSICAL INSTRUMENT TUNER FOR SIMULTANEOUSLY TUNING ALL STRINGS WHILE MUTING THE INSTRUMENT

(76) Inventors: Dalton L. POTTER, Rockville, MD (US); Frank Strazzabosco, Erie, CO (US)

(21) Appl. No.: 12/706,889

(22) Filed: Feb. 17, 2010

(51) Int. Cl. G10H 3/14; G10D 3/14

(52) U.S. Cl. 84/730; 84/312 R

(57) ABSTRACT

A tuning device includes a weighted housing which reduces transfer of vibrations of all strings of a stringed musical instrument to a body of the stringed musical instrument, and tuning circuitry which simultaneously detects a pitch of each vibrating string. A method of tuning a stringed musical instrument includes attaching an electronic tuning device to a bridge of the stringed musical instrument, activating the electronic tuning device, causing a plurality of strings of the stringed musical instrument to vibrate simultaneously, and individually adjusting a pitch of each of the simultaneously vibrating strings in accordance with a pitch indication for each of the strings produced by the electronic tuning device.

### BACKGROUND OF THE INVENTION

1. Field of the Invention

Apparatuses and methods consistent with the present invention relate to a tuning device for tuning stringed musical instruments and a method of using the tuning device, and more particularly to a tuning device which mutes a stringed musical instrument while providing the ability to simultaneously tune all of the strings, and a method for tuning a stringed musical instrument using the tuning device.

2. Description of the Related Art

Conventional tuning devices for acoustic musical instruments use a microphone, for example, an omnidirectional microphone, to pick up the ambient sound produced by the musical instrument. Circuitry within the tuning device analyzes the ambient sound picked up by the microphone, and displays the pitch properties of the sound, i.e., whether the pitch is sharp or flat, using, for example, a liquid crystal display (LCD) meter, a VU meter, or a series of light emitting diodes (LEDs).

Since the conventional tuning device uses a microphone to pickup ambient sound, only one instrument can be tuned at a time. If the strings on more than one instrument are sounded, the microphone in the conventional tuner picks up multiple audio signals from the different instruments, making it difficult or impossible to accurately tune the one instrument. For similar reasons, only one string of the instrument can be tuned at a time. Further, other ambient room sounds, for example, audience noise in a concert hall, also interfere with the ability of the conventional tuner to accurately identify the sound of the desired instrument and display accurate tuning information.

### SUMMARY OF THE INVENTION

Exemplary embodiments of the present invention overcome the disadvantages described above and other disadvantages not described above. Also, the present invention is not required to overcome the disadvantages described above, and an exemplary embodiment of the present invention may not overcome any of the problems described above.

The present invention provides a tuning apparatus which mutes a stringed musical instrument while simultaneously providing the ability to tune the instrument, and a method for tuning the stringed musical instrument using the tuning device.

According to an aspect of the present invention there is provided a weighted housing which removably attaches to a bridge of the stringed musical instrument and mutes the instrument. The housing may be formed of nickel plated cast brass or other suitable material to provide an appropriate housing weight. Alternatively, a weight may be added to the housing to provide the appropriate weight.

According to another aspect of the present invention there is provided tuning circuitry which provides accurate real time tuning information combined with the weighted housing. The circuitry of the tuning apparatus provides simultaneous detection of pitches of a plurality of strings allowing for simultaneous tuning at appropriate pitch intervals between the strings.

According to yet another aspect of the present invention there is provided a display of the real time tuning information. Light emitting diodes (LEDs) may be caused to blink at predetermined blink rates as an indication of an actual pitch of a string with respect to a target pitch of the string.

Exemplary embodiments of the present invention also provide a tuning method for a stringed musical instrument while muting the instrument.

According to an aspect of the present invention, the method may include attaching an electronic tuning device to a bridge of the stringed musical instrument, activating the electronic tuning device, causing a plurality of strings of the stringed musical instrument to vibrate simultaneously, and individually adjusting a pitch of each of the simultaneously vibrating strings in accordance with a pitch indication for each of the strings produced by the electronic tuning device.

### BRIEF DESCRIPTION OF THE DRAWINGS

The above and other aspects and features of the present invention will be more apparent by describing exemplary embodiments of the present invention with reference to the accompanying drawings, in which:

FIG. 1 is an illustration of a tuning apparatus according to an exemplary embodiment of the present invention;

FIG. 2 is an illustration of showing details of a weighted housing according to an exemplary embodiment of the present invention;

FIG. 3 is a block diagram illustrating electronic tuning circuitry of a tuning apparatus according to an exemplary embodiment of the present invention;

FIG. 4 is a block diagram illustrating a frequency detection stage according to an exemplary embodiment of the present invention;

FIG. 5 is a block diagram illustrating display circuitry according to an exemplary embodiment of the present invention; and

FIG. 6 is a flow chart illustrating a method of tuning a stringed musical instrument using a tuning apparatus according to an exemplary embodiment of the present invention.

### DETAILED DESCRIPTION OF EXEMPLARY EMBODIMENTS

Reference will now be made in detail to the exemplary embodiments of the present invention, examples of which are illustrated in the accompanying drawings, wherein like reference numerals refer to like elements throughout. The exemplary embodiments are described below so as to explain the present invention by referring to the figures.

The present invention is directed to a tuning device for a stringed musical instrument, for example, but not limited to, a violin. The tuning device combines a practice mute which mutes the sound from the musical instrument being tuned with electronic tuning circuitry which detects and displays the pitch of all strings of the stringed instrument simultaneously. The tuning device provides the capability of tuning the stringed instrument under any playing condition.

For ease of explanation and understanding, exemplary embodiments of the present invention will be described with respect to a violin. However, one of ordinary skill in the art will recognize that the principles and features of the exemplary embodiments are not limited to use with a violin, but may be extended to operation with other stringed instruments.

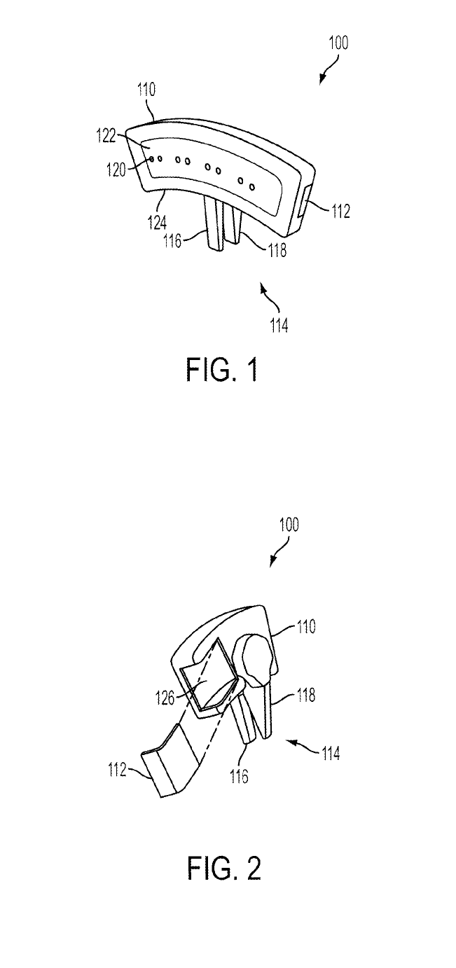

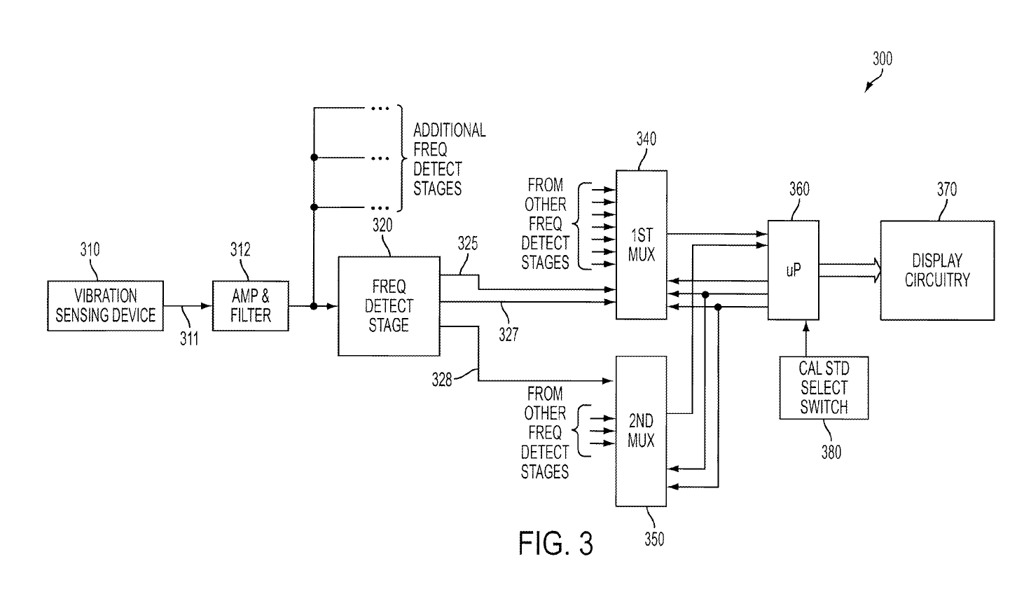

FIGS. 1 and 2 are illustrations of a tuning apparatus according to an exemplary embodiment of the present invention. The tuning apparatus 100 includes a weighted housing 110 and electronic tuning circuitry 300 (see FIG. 3). The electronic circuitry 300 may be disposed within the weighted housing 110. A back opening cover 112 on the weighted housing 110 may provide access for installing the circuitry 300 as well as for providing access to a battery (not shown) which provides power to the electronic circuitry 300.

The weighted housing 110 performs a function of muting the acoustic sound of the instrument. The housing 110 is weighted in order to mute the instrument when the strings of the instrument are caused to vibrate, for example, during tuning of the instrument. In general, the housing should have a weight of at least 2.8 ounces to achieve the mute function, but this weight may vary. For example, the weight of the housing 110 may be 3.5 ounces for a violin or viola, and 5 ounces for a cello. The housing weight excludes any weight introduced by the electronic circuitry 300. The present invention is not limited to these specific weights, and the indicated weights may vary by several ounces. Depending on user preference as well as the particular stringed instrument, a weighted housing 110 having a heavier weight may be used in order to achieve the mute function.

The housing 110 may be formed of nickel plated cast brass. The weighted feature may be accomplished by the nickel and brass material forming the housing. The thickness and size of the housing 110 may be manipulated to achieve the desired weight which provides the desired muting result. However, construction of the housing 110 is not limited to this material and other materials providing appropriate weight may be used to form the housing 110. Alternatively, a weight may be attached to a lighter weight housing to achieve a desired tuning device weight.

The weighted housing 110 is attached to the instrument by clamping or press-fitting the housing 110 onto a bridge of the stringed instrument, thereby absorbing vibrations and reducing the audible sound projected from the instrument. The weighted housing 110 is provided with an attaching mechanism 114 for attaching the tuning apparatus 100 to the bridge of the instrument. The shape of the bottom of the housing 124, when viewed from a front side, may correspond to the shape of the bridge of a musical instrument on which the housing 110 is to be attached; however, it is not required.

The attaching mechanism 114 may include a stationary member 116 and a movable member 118. The movable member 118 may be urged towards the stationary member 116 by, for example, but not limited to, a spring (not shown). Alternatively, any releasable method of urging the movable member 118 towards the stationary member 116 may be used, including, but not limited to, elastic properties of the materials used to construct the attaching mechanism 114. Further, more than one stationary member and/or more than one movable member may be used as part of the attaching mechanism 114.

Since the weighted housing 110 performs a function of muting the acoustic sound of the instrument, tuning of an instrument may be accomplished in an orchestral setting without disturbing other members of the orchestra and the audience. In effect, each string member of an orchestra could use a tuning device to tune their instruments simultaneously without affecting the tuning devices used by others.

The weighted housing 110 is large enough to accommodate the electronic tuning circuitry 300 and a battery for providing power to the electronic tuning circuitry 300. The tuning circuitry 300 and battery may be inserted into an interior hollow portion 126 of the housing 110 which is accessible through a back opening of the housing 110.

FIG. 3 is a block diagram illustrating electronic tuning circuitry of a tuning apparatus according to an exemplary embodiment of the present invention. As illustrated in FIG. 3, the electronic tuning circuitry 300 includes a vibration sensing device 310, a plurality of frequency detection stages 320, first multiplexer 340, second multiplexer 350, a processor 360, display circuitry 370 and a calibration frequency standard selection switch 380. The electronic tuning circuitry 300 may also include circuitry 312 to amplify and/or filter an output signal from the vibration sensing device 310.

The vibration sensing device 310 may be, for example, but not limited to, a piezoelectric vibration sensor. When the tuning apparatus 100 is attached to a stringed instrument and the strings are caused to vibrate, the vibration sensing device 310 senses the vibrations of each of the simultaneously vibrating strings of the musical instrument. The vibration sensing device 310 outputs an electrical signal 311 which corresponds to a composite of the sensed vibration frequencies of the vibrating strings.

The composite electrical signal 311 output from the vibration sensing device 310 is received by each of the plurality of frequency detection stages 320. One of ordinary skill in the art will recognize that the number of frequency detection stages may vary depending on the number of strings designed to be tuned by the tuning apparatus. Accordingly, the operation of the frequency detection described below is representative of the operation of all of the frequency detection stages.

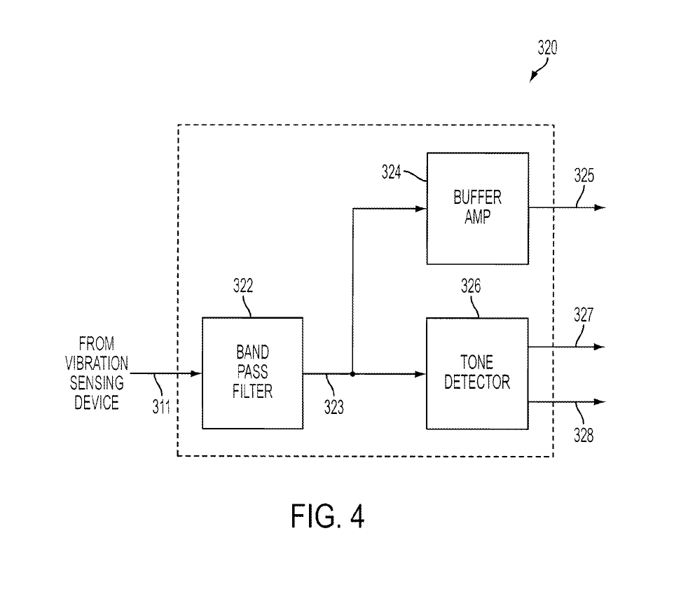

FIG. 4 is a block diagram illustrating a frequency detection stage according to an exemplary embodiment of the present invention. Each frequency detection stage 320 includes a band pass filter 322, a buffer amplifier 324 and a tone detector 326. The band pass filter 322 inputs the composite electrical signal 311 output from the vibration sensing device 310. The band pass filter 322 passes a specific frequency corresponding to a center frequency of vibration, i.e., an in-tune pitch, of a properly tuned particular string, as well as frequencies in a limited range surrounding the center frequency. Thus, each of the plurality of frequency detection stages 320 detects a frequency corresponding to the frequency of vibration of a different one of the strings to be tuned.

Each band pass filter 322, therefore, outputs a frequency signal 323 having a frequency corresponding to the actual frequency of vibration of one particular string. An output signal 323 of the band pass filter 322 is input to the buffer amplifier 324 and the tone detector 326. The buffer amplifier 324 buffers and outputs a signal 325 corresponding to the actual frequency of vibration of the particular string.

The tone detector 326 generates and outputs a target frequency signal 327, i.e., a frequency corresponding to an in-tune pitch, for the string corresponding to the frequency detection stage 320. The tone detector 326 also operates as a phase lock loop which outputs a lock signal 328 when the actual frequency of vibration of the string corresponding to the frequency detection stage 320 is within a specified frequency range of the target frequency output signal 327 provided by the tone detector 326. The actual frequency output signal 325 from the buffer amplifier 324, the target frequency output signal 327 from the tone detector 326 and the lock signal 328 output from the tone detector 326 are output from the frequency detection stage 320.

Referring back to FIG. 3, the actual frequency output signal 325 and the target frequency output signal 327 from the frequency detection stage 320 are input to the first multiplexer 340, and the lock signal 328 output from the frequency detection stage 320 is output to the second multiplexer 350. As previously noted, the exemplary embodiment described herein relates to a violin having four strings. Thus, in the exemplary embodiment, four frequency detection stages 320 with their associated outputs (actual frequency, target frequency and lock signal), are used, one of the four frequency detection stages 320 corresponding to each of the violin strings. The first multiplexer 340 therefore inputs the actual frequencies for the four strings and the target frequencies for the four strings. The second multiplexer 350 inputs the lock signals from each of the four frequency detection stages 320. The multiplexers 340, 350 are controlled by the processor 360.

The processor 360 addresses the first multiplexer 340 to read the actual frequency signal 325 and the target frequency signal 327 output from one of the frequency detection stages 320 and addresses the second multiplexer 350 to read the lock signal 328 output from the same frequency detection stage 320. The processor 360 compares the actual frequency signal 325 and the target frequency signal 327 and controls the display circuitry 370 based on results of the comparison and the value of the lock signal.

Since different frequency standards for calibration may be used in different parts of the world, the calibration standard selection switch 380 allows setting of the frequency standard for performing calibration to alternate calibration standard frequencies, for example, but not limited to, 440 Hz and 442 Hz.

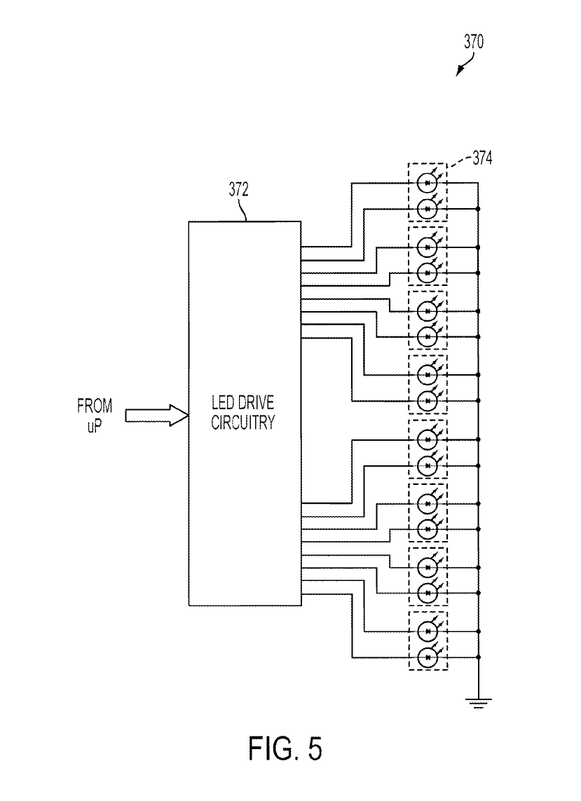

FIG. 5 is a block diagram illustrating display circuitry according to an exemplary embodiment of the present invention. The display circuitry 370 includes light emitting diodes (LEDs) 374 and driver circuitry 372 which causes the LEDs 374 to illuminate as an indication of the pitch of a string relative to a target, i.e., in-tune, pitch.

In an exemplary embodiment of the present invention, the LEDs 374 may blink as an indication of the degree to which the actual pitch of a string matches the target pitch. A cent scale, where 1200 cents is equal to one octave, may be used to determine blink rates of the LEDs 374 with respect to pitch. For example, five blink rates may be defined. If the difference between actual and target pitch is greater than +/−240 cents, the LEDs 374 may blink at the slowest rate (Blink rate 1). If the difference between actual and target pitch is greater than +/−120 cents, the LEDs 374 may blink at the next higher rate (Blink rate 2). If the difference between actual and target pitch is greater than +/−60 cents, the LEDs 374 may blink at the next higher rate (Blink rate 3). If the difference between actual and target pitch is greater than +/−30 cents, the LEDs 374 may blink at the next higher rate (Blink rate 4). If the difference between actual and target pitch is equal to or less than +/−15 cents, the LEDs 374 may blink at the next higher rate (Blink rate 5).

If, however, the lock signal 328 indicates that the actual frequency signal 325 detected by the frequency detection stages 320 matches the target frequency signal 327 within a specified tolerance, which may be in a frequency range corresponding to a pitch difference within a range of +/−30 cents of the target pitch, then the pitch of the string matches the target pitch. The driver circuitry 372 then causes the LEDs 374 to illuminate steadily as an indication that the string is in tune.

Alternatively, the LEDs 374 may initially blink at a high rate and blink at slower rates as the actual pitch of a string approaches a target pitch. When the actual pitch of the string matches the target pitch within a specified tolerance, the LEDs 374 may illuminate steadily.

In the exemplary embodiment, the tuning apparatus displays the tuning pitch of each individual string (up to four strings in the exemplary embodiment), and how sharp or flat the string tone is, relative to the target pitch. This is accomplished with four pairs of LEDs lights, one pair for each string, where the LEDs of each pair are positioned side-by-side. When a given string is caused to vibrate, the corresponding pair of LEDs becomes active. If the pitch of the string is too low (flat) the left-side LED blinks red. As the pitch of the string is tuned closer to the target note, the blinking of the red LED speeds up until the target pitch is achieved at which point the LED glows steady green. If the pitch is too high (sharp) the right-side LED blinks red.

As the pitch of the string is tuned closer to the target note, the blinking of the red LED speeds up until the target pitch is achieved at which point the LED glows steady green. If the adjacent string is played simultaneously, the same tuning function will occur with the second string at the same time as the first string. When the pairs LEDs corresponding to each string are glowing steady green, not only are each of the strings in tune individually, but they are also in tune with each other at the desired interval of a perfect fifth.

Although the foregoing disclosure describes a scheme for lighting LEDs to indicate the pitch of each string to the user, this lighting scheme may be altered to use other lights or blinking patterns. Further, positioning of the LEDs is not limited to a side-by-side configuration and may be, for example but not limited to, and over-under configuration. Also, other visual indicia not specifically described herein that would visually indicate the flat, sharp and perfect pitches of the strings are contemplated by this disclosure.

Referring back to FIGS. 1 and 2, the housing 110 is large enough to accommodate the tuning circuitry 300, including the LEDs 374 and a battery. The components may be inserted into an interior hollow portion 126 of the housing 110 which is accessible through a back opening of the housing 110.

The hollow interior portion 126 accommodates a printed circuit board (PCB) on which the electronic tuning circuitry 300 of the electronic tuning apparatus is mounted. A battery, for providing power to the electronic tuning circuitry 300 may be inserted along with the PCB into the hollow interior portion 126 of the housing 110.

Once the electronic tuning components are inserted into the hollow interior portion 126 of the housing 110, a back opening cover 112 is installed over the back opening of the housing 110 to enclose the electronic tuning components within the hollow interior portion of the housing 110. A small lip may surround the back opening to allow the edges of the back opening cover 112 to fit securely and provide a smooth back surface for the housing 110 upon assembly.

The housing 110 includes holes 120 formed on a front face 122 of the housing 110, so as to allow one of the LEDs 374 to be visible through each one the holes 120. In the exemplary embodiment, eight holes 120 allow the eight LEDs 374 to be visible. The holes 120 are arranged such that a pair of holes are associated with each string of the musical instrument. For example, the pair of holes may be arranged horizontally such that one hole 120 of the pair of holes is positioned approximately to each side of each string.

Exemplary embodiments of the present invention may also include a switch (not shown), for example, but not limited to, a spring loaded micro switch, positioned on the housing in such a manner as to be automatically activated when the tuning apparatus is installed on a bridge of a musical instrument, thus activating the on/off function for the device. For example, the switch may be provided at a bottom face 124 of the housing 110 such that the switch will contact the instrument bridge when the tuning apparatus is installed, thereby activating the switch. Alternatively, the switch may be positioned to be operated by the user to activate the on/off function for the device.

In an exemplary embodiment, the switch may be inserted into the hollow interior portion 126 of the housing 110 and into a switch hole (not shown) formed at the bottom face 124 of the housing 110 so that the switch projects at least partially through the switch hole. The switch may then be operated to activate the on/off function simply by installing the device on the bridge of the stringed instrument.

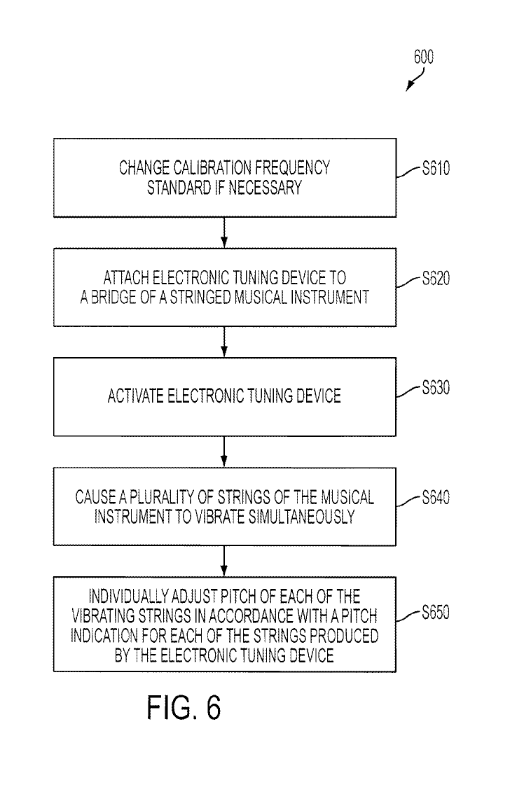

FIG. 6 is a flow chart 600 illustrating a method of tuning a stringed musical instrument using a tuning apparatus according to an exemplary embodiment of the present invention. A method of tuning a stringed musical instrument using an exemplary embodiment of the electronic tuning device 100 includes, changing the calibration standard frequency, if necessary (S610), and attaching the electronic tuning device 100 to a bridge of a stringed musical instrument (S620). The electronic tuning device 100 is then activated (S630). The electronic tuning device 100 may be activated with a switch as described above.

After the electronic tuning device 100 is activated, a plurality of strings of the stringed musical instrument are caused to vibrate simultaneously by, for example, but not limited to, drawing a bow across the string (S640). As a result of causing the strings to vibrate, the electronic tuning device 100 displays an indication of the pitches of each of the vibrating strings as described above.

The pitch of each of the simultaneously vibrating strings is individually adjusted by a user in accordance with the pitch indication for each of the strings produced by the electronic tuning device 100 (S650).

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A tuning device, comprising:
a weighted housing which reduces transfer of vibrations of all strings of a stringed musical instrument to a body of the stringed musical instrument; and
tuning circuitry which simultaneously detects a pitch of each vibrating string.

2. The tuning device of claim 1, further comprising a display which simultaneously displays an indication of the pitch of each vibrating string detected by the tuning circuitry.

3. The tuning device of claim 2, wherein the tuning circuitry further comprises a vibration sensor which senses an actual vibration frequency of each of the strings of the stringed musical instrument simultaneously

4. The electronic tuning apparatus of claim 3, wherein the vibration sensor comprises a piezoelectric sensor.

5. The tuning device of claim 2, wherein the display comprises a plurality of light emitting diodes which indicate a sharp pitch or a flat pitch for each string.

6. The tuning device of claim 2, wherein the display comprises one pair of light emitting diodes corresponding to each one of the strings, wherein one of the light emitting diodes of the pair illuminates to indicate a sharp pitch, the other light emitting diodes of the pair illuminates to indicate a flat pitch, and both light emitting diodes illuminate to indicate an in-tune pitch for each string.

7. The tuning device of claim 6, wherein the respective illuminated light emitting diode indicating a sharp pitch or a flat pitch blinks at a slow rate to indicate that the actual pitch is far from the target pitch, and increases its blink rate as the actual pitch approaches the target pitch.

8. The tuning device of claim 6, wherein both light emitting diodes illuminate to indicate an in-tune pitch when the actual pitch is within +/−30 cents of the target pitch.

9. The tuning device of claim 1, further comprising a calibration standard selection switch to select among alternative calibration standard frequencies.

10. The tuning device of claim 1, wherein said weighted housing removably attaches to a bridge of the stringed musical instrument.

11. The tuning device according to claim 1, further comprising a switch disposed on the weighted housing which activates an on/off function of the tuning device when the tuning device is installed on the musical instrument.

12. The tuning device according to claim 1, wherein the housing is formed of nickel plated cast brass.

13. The tuning device according to claim 1, wherein the housing weighs at least 2.8 ounces.

14. The tuning device according to claim 1, wherein the housing weighs approximately 3.5 to 5 ounces.

15. The tuning device of claim 1, wherein the tuning circuitry is disposed within an interior compartment of the weighted housing.

16. The tuning device of claim 1, further comprising a calibration standard selection switch to select among alternative calibration standard frequencies.

17. An electronic tuning apparatus for a stringed musical instrument, the electronic tuning apparatus comprising:
a weighted housing; and
electronic tuning circuitry which detects a pitch of each vibrating string of the stringed musical instrument simultaneously,
wherein the electronic tuning circuitry comprises:
a vibration sensor which senses an actual vibration frequency of each of the strings of the stringed musical instrument simultaneously;
a frequency generator which generates a target frequency corresponding to a target pitch of each of the strings;
a processor which compares the actual frequency to the target frequency for each of the strings; and
display circuitry which indicates a sharp pitch, a flat pitch or an in-tune pitch for each string simultaneously.

18. The electronic tuning apparatus of claim 17, wherein the vibration sensor comprises a piezoelectric sensor.

19. The electronic tuning apparatus of claim 17, wherein the display comprises one pair of light emitting diodes corresponding to each one of the strings, wherein one of the light emitting diodes of the pair illuminates to indicate a sharp pitch, the other light emitting diodes of the pair illuminates to indicate a flat pitch, and both light emitting diodes illuminate to indicate an in-tune pitch for each string.

20. The electronic tuning apparatus of claim 17, wherein the respective illuminated light emitting diode indicating a sharp pitch or a flat pitch blinks at a slow rate to indicate that the actual pitch is far from the target pitch, and increases its blink rate as the actual pitch approaches the target pitch.

21. The electronic tuning apparatus of claim 17, wherein both light emitting diodes illuminate to indicate an in-tune pitch when the actual pitch is within +/−30 cents of the target pitch.

22. The electronic tuning apparatus of claim 16 further comprising a switch disposed on the electronic tuning apparatus which activates an on/off function when the electronic tuning apparatus is installed on the musical instrument.

23. The electronic tuning apparatus of claim 16, wherein the tuning circuitry is disposed within an interior compartment of the weighted housing.

24. A method of tuning a stringed musical instrument using an electronic tuning device, the method comprising:
attaching an electronic tuning device to a bridge of the stringed musical instrument;
activating the electronic tuning device;
causing a plurality of strings of the stringed musical instrument to vibrate simultaneously; and
individually adjusting a pitch of each of the simultaneously vibrating strings in accordance with a pitch indication for each of the strings produced by the electronic tuning device.

25. The method of claim 24, wherein the musical instrument is a bowed-string musical instrument.
